(19) United States
(12) Patent Application Publication
(10) Pub. No.: US 2013/0318074 A1
(43) Pub. Date: Nov. 28, 2013

(54) METHOD, SYSTEM, CLIENT AND SERVER FOR ACQUIRING AND PUSHING CONTENT IN INTERNET COMMUNITY

(71) Applicant: Zhihao Zheng, Shenzhen City (CN)

(72) Inventor: Zhihao Zheng, Shenzhen City (CN)

(73) Assignee: TENCENT TECHNOLOGY (SHENZHEN) COMPANY LIMITED, Shenzhen City (CN)

(21) Appl. No.: 13/992,679

(22) PCT Filed: Sep. 2, 2011
(86) PCT No.: PCT/CN2011/079279

§ 371 Date: Aug. 14, 2013

(30) Foreign Application Priority Data
Dec. 8, 2010 (CN) 201010578847.X

(51) Int. Cl. H04L 29/06; G06F 17/30

(52) U.S. Cl. CPC H04L 65/403; G06F 17/30554
USPC 707/722; 715/753

(57) ABSTRACT

The present invention relates to the field of Internet technologies, and provides a method, system, client and server for acquiring and pushing content in an Internet community. The method for acquiring content in an Internet community includes: when the cursor of a client stays in a relationship chain content display area or a hotspot content display area, triggering the client to send information of a display area currently activated by a user to a server; and displaying latest community content in a corresponding display area after the client receives the latest community content. According to the present invention, users, after simply setting a user range for view or customizing a concerned keyword or subject, view community created by users within the corresponding range by using the real-time pushing function in real time. This greatly simplifies the operation manner of users, and enhances user's real-time viewing experience.

### FIELD OF THE INVENTION

The present invention relates to the field of Internet technologies, and in particular, to a method, system, client and server for acquiring and pushing content in an Internet community.

### BACKGROUND OF THE INVENTION

In the prior art, content display in an Internet community is mainly achieved by triggering related requests by user's operations on a client and subsequently acquiring desired data. The client herein refers to a product form of the Internet community based on terminal-to-server data exchange on different platforms (including but not limited to PCs, mobile phones, and related mobile terminals) by using the web-specific or client-specific technology. However, when a user opens a web page, the displayed Internet community content is outdated. To view the up-to-date Internet community content, the user needs to manually perform related operations to acquire the latest Internet community content. In addition, community content generated by other users in the same community is distributed in various types of products, and consequently, the user cannot view the current community content in real time. Accordingly, in the prior art, the Internet community content is an outdated content, and users who want to view the latest Internet community content need to manually take the initiative through related operations to acquire the latest content, thereby causing inconvenience to users' viewing experience in an Internet community.

### SUMMARY OF THE INVENTION

Objectives of the present invention are to provide a method, system, client and server for acquiring and pushing content in an Internet community, which are directed to solving the following problem: in the prior art, the client webpage fails to present up-to-date Internet community content, and users need to acquire latest information by related operations when viewing the up-to-date Internet community content, thereby causing inconvenience to users' viewing of content in an Internet community.

An embodiment of the present invention provides a method for acquiring content in an Internet community, where the method includes:

when the cursor of a client stays in a relationship chain content display area or a hotspot content display area, triggering the client to send information of the display area currently activated by a user to a server; and

displaying the latest community content in a corresponding display area after the client receives the latest community content.

An embodiment of the present invention provides a system for acquiring content in an Internet community, where the system includes:

a triggering module, configured to, when the cursor of a client stays in a relationship chain content display area or a hotspot content display area, trigger the client to send information of the display area currently activated by a user to a server; and

a display control module, configured to display the latest community content in a corresponding display area after the client receives the latest community content.

An embodiment of the present invention provides a client having the system for acquiring content in an Internet community.

An embodiment of the present invention provides a method for pushing content in an Internet community, where the method includes:

receiving, by a server, information of the display area currently activated by a user from a client;

acquiring, by the server according to the information of the display area currently activated by the user, the latest community content corresponding to the display area; and

pushing, by the server, the latest community content to the corresponding display area of the client.

An embodiment of the present invention provides a system for pushing content in an Internet community, where the system includes:

an information pushing module, configured to receive information of the display area currently activated by a user from a client; and

an acquiring module, configured to acquire, according to the information of the display area currently activated by the user, the latest community content corresponding to the display area;

where the information pushing module is further configured to push the latest community content to a corresponding display area of the client.

An embodiment of the present invention provides a server having the system for pushing content in an Internet community.

According to the present invention, when the cursor of a user stays in a display area of a relationship chain content display module or a hotspot content display module, a corresponding display module is triggered to send information indicating which display module is currently activated by the user to a server; the server acquires, according to the display module currently activated by the user, the latest community content corresponding to the display module from a data storage module, and pushes the latest community content to the corresponding display module of a client; and the display module of the client, after receiving the latest community content, displays the latest community content in the display area of the corresponding display module for the user to view. According to embodiments of the present invention, the user, after simply setting a user viewing range or customizing a concerned keyword or subject, can view community content created by users within the set range by using the real-time pushing function in real time. This greatly simplifies the operation manner of users, and enhances user's real-time viewing experience.

### BRIEF DESCRIPTION OF THE DRAWINGS

FIG. 1 is a schematic flowchart of a method for acquiring content in an Internet community according to an embodiment of the present invention;

FIG. 2 is a schematic structural diagram of a system for acquiring content in an Internet community according to an embodiment of the present invention;

FIG. 3 is a schematic flowchart of a method for pushing content in an Internet community according to an embodiment of the present invention; and

FIG. 4 is a schematic structural diagram of a system for pushing content in an Internet community according to an embodiment of the present invention.

### DETAILED DESCRIPTION OF THE EMBODIMENTS

To make the objective, technical solutions, and beneficial effects of the present invention more clear, the following section describes the technical solutions of the present invention with reference to the accompanying drawings and specific embodiments. It should be understood that the embodiments described here are only exemplary ones for illustrating the present invention, and are not intended to limit the present invention.

In the embodiments of the present invention, when the cursor of a user stays in a display area of a relationship chain content display module or a hotspot content display module, a corresponding display module is triggered to send information indicating which display module is currently activated by the user to a server; the server acquires, according to the display module currently activated by the user, the latest community content corresponding to the display module from a data storage module, and pushes the latest community content to the corresponding display module of a client; and the display module of the client, after receiving the latest community content, displays the latest community content in the display area of the corresponding display module for the user to view. The embodiments of the present invention solve the following problem: in the prior art, the client webpage fails to present up-to-date Internet community content, and users need to acquire latest information by related operations when viewing the up-to-date Internet community content, thereby causing inconvenience to users' viewing of content in an Internet community.

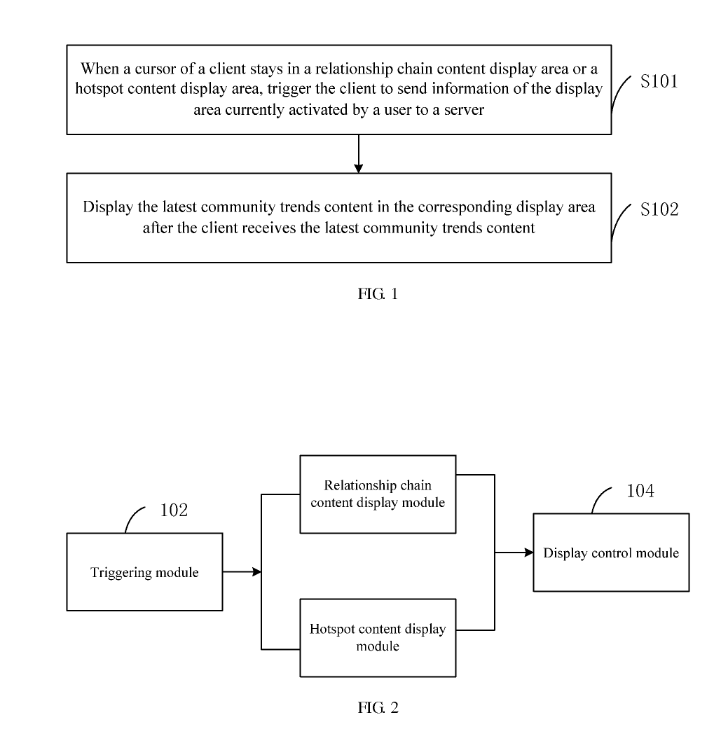

Referring to FIG. 1, an implementation flowchart of a method for acquiring content in an Internet community according to an embodiment is illustrated, including the following steps:

In step S101, when the cursor of a client stays in a relationship chain content display area or a hotspot content display area, the client is triggered to send information of the display area currently activated by a user to a server.

In the embodiments of the present invention, when the cursor of a user stays in a display area of the relationship chain content display module or the hotspot content display module, a corresponding display module is triggered to send information indicating which display module is currently activated by the user to the server.

The relationship chain content display module is configured to display community content of different types of relationship chain users. Users can perform operations including but not limited to: browse, create, discuss, reply, share, post, and comment. The relationship chain type includes but not limited to: QQ friends, alumni, colleagues, friends, families, and classmates. The community content includes but not limited to texts, pictures, videos, audios, and a mixed data packet thereof.

The hotspot content display module is configured to display community hotspot content. Users can search their interested community content in the area, view detailed hotspot information, make comments on and replies to, and view the list of users who concern corresponding content in the area. Concern refers to but not limited to the following operations: browse, create, discuss, reply, share, post, and comment.

In step S102, the latest community content is displayed in the corresponding display area after the client receives the latest community content.

In the embodiments of the present invention, after receiving the latest community content, the display module of the client displays the latest community content in the corresponding area of the client for users.

In the embodiments of the present invention, the latest community content is from: community content generated by users by write operations on the client; and community content generated and aggregated by other external community products for display on the client received by an external content access module of the server.

In the embodiments of the present invention, step S102 specifically includes: after the client receives the latest community content, determining a display area to which the latest community content belongs, and displaying the latest community content in the corresponding display area.

In the embodiments of the present invention, after receiving the latest community content, a data real-time updating module of the client determines to which display module the latest community content belongs, and forwards the latest community content to the corresponding display module.

According to a preferred embodiment of the present invention, the method for acquiring content in an Internet community further includes the following steps:

after the user performs an operation on community content on the client, submitting, by a corresponding display module of the client, an operation result to an operation management module of the server; where the operation on the community content includes but not limited to such operations as create, discuss, reply, share, post, and comment; and

receiving, by the client, information of the operation result returned by the server, and displaying the information in the corresponding display area of the display module for the user to view.

According to another preferred embodiment of the present invention, the method for acquiring content in an Internet community further includes the following steps:

receiving, by the display module of the client, a keyword entered by the user for searching hotspot content, and submitting the keyword to a search management module of the server; and

receiving, by the display module of the client, a search result returned by the server, and displaying the search result in the corresponding display area of the display module for the user to view.

According to another preferred embodiment of the present invention, after step S101 is performed, the method for acquiring content in an Internet community further includes the following steps:

receiving, by the server, information of the display area currently activated by the user from the client;

acquiring, by the server according to the information of the display area currently activated by the user, the latest community content corresponding to the display area; and

pushing, by the server, the latest community content to the corresponding display area of the client.

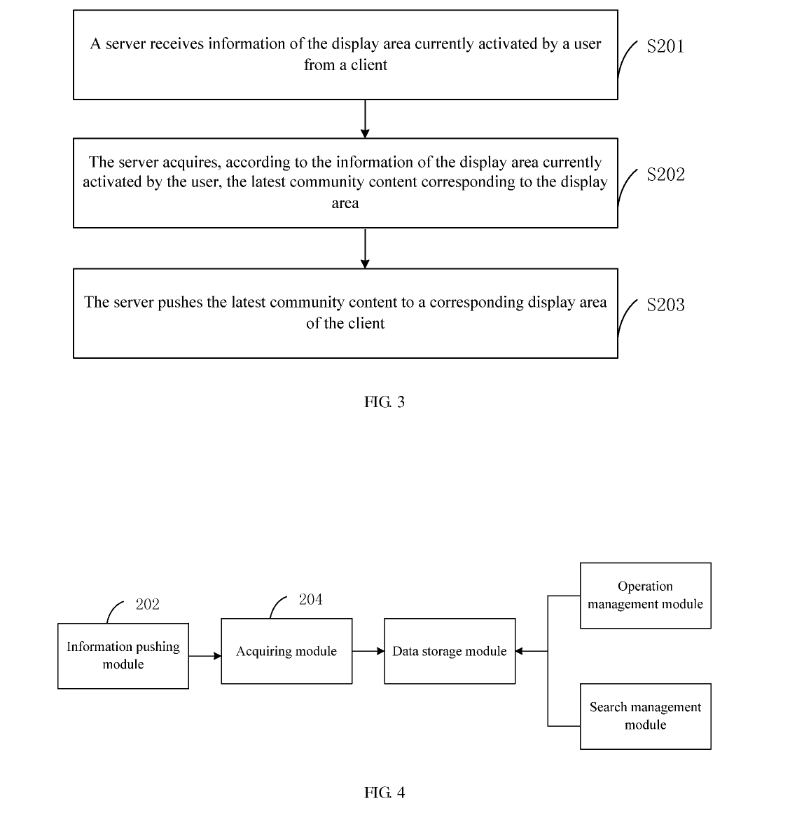

Referring to FIG. 3, an implementation flowchart of a method for pushing content in an Internet community according to an embodiment is illustrated, including the following steps:

In step S201, a server receives information of the display area currently activated by a user from a client.

In the embodiments of the present invention, the server receives information indicating which display module is currently activated by the user from the corresponding display module of the client.

In step S202, the server acquires, according to the information of the display area currently activated by the user, the latest community content corresponding to the display area.

In the embodiments of the present invention, the server acquires, according to the display module currently activated by the user, the latest community content corresponding to the display module from the dada storage module.

In the embodiments of the present invention, the latest community content includes but not limited to: texts, pictures, videos, audios and a mixed data packet thereof generated by such operations as create, discuss, reply, share, post, and comment.

In step S203, the server pushes the latest community content to a corresponding display area of the client.

In the embodiments of the present invention, the server pushes the latest community content to a corresponding display module of the client.

In the embodiments of the present invention, the server pushes, at preset frequency, the latest community content to the corresponding display module of the client. For example, the latest community content is pushed to the display module of the client at intervals of 10 seconds, 30 seconds, or 60 seconds.

According to another preferred embodiment of the present invention, when detecting that the display module in the data storage module has updated data, the server pushes the latest community content detected in real time to the display module of the client.

According to a preferred embodiment of the present invention, the method for pushing content in an Internet community further includes the following steps:

receiving, by an operation management module of the server, a community content operation result submitted by the client, and storing the operation result into a data storage module; and

returning, by the server, information of the operation result to the corresponding display module of the client.

According to a preferred embodiment of the present invention, the method for pushing content in an Internet community further includes the following steps:

receiving, by an search management module of the server, a keyword submitted by the display module of the client for searching hotspot content; and

acquiring, by the search management module according to the keyword, corresponding content from the data storage module, and returning the content to the corresponding display module of the client.

According to another preferred embodiment of the present invention, prior to step S201, the method for pushing content in an Internet community further includes the following steps:

when the cursor of a client stays in a relationship chain content display area or a hotspot content display area, triggering the client to send information of a display area currently activated by a user to a server.

According to another preferred embodiment of the present invention, after step S203 is performed, the method for pushing content in an Internet community further includes the following steps:

displaying the latest community content in a corresponding display area after the client receives the latest community content.

In the embodiments of the present invention, the corresponding content mainly includes but not limited to:

hotspot community content corresponding to the keyword;

a list of users who concern one or more pieces of community content (may be presented in the form of head portrait, nickname, or remark), where the number of users in the displayed user list is presented according to the numbers configured by the search management module of the server.

Users can view hotspot content and a list of users who concern, and view related community information of an individual user.

FIG. 2 illustrates a structure of a system for acquiring content in an Internet community according to an embodiment of the present invention. For ease of description, FIG. 2 merely illustrates elements or parts related to the embodiments of the present invention. The system for acquiring content in an Internet community includes a triggering module 102 and a display control module 104. The system for acquiring content in an Internet community may be a software unit built-in a client, a hardware unit, or a unit integrating software and hardware.

The triggering module 102 is configured to, when the cursor of a client stays in a relationship chain content display area or a hotspot content display area, trigger the client to send information of a display area currently activated by a user to a server.

The display control module 104 is configured to display the latest community content in a corresponding display area after the client receives the latest community content.

According to the embodiments of the present invention, the system for acquiring content in an Internet community further includes a data real-time updating module.

The data real-time updating module is configured to, after the client receives the latest community content, determine the display area to which the latest community content belongs, and display the latest community content in the corresponding display area.

According to a preferred embodiment of the present invention, the system for acquiring content in an Internet community further includes a submitting module.

The submitting module is configured to, after the user performs an operation on community content on the client, submit an operation result to the server; wherein the operation on the community content includes but not limited to such operations as create, discuss, reply, share, post, and comment.

The display control module 104 is further configured to receive information of the operation result returned by the server, and display the information in the corresponding display area for the user to view.

According to a preferred embodiment of the present invention, the system for acquiring content in an Internet community further includes a keyword submitting module.

The keyword submitting module is configured to receive a keyword entered by the user for searching hotspot content, and submit the keyword to the server.

The display control module is further configured to receive a search result returned by the server, and display the search result in the corresponding display area for the user to view.

FIG. 4 illustrates a structure of a system for pushing content in an Internet community according to an embodiment of the present invention. For ease of description, FIG. 4 merely illustrates elements or parts related to the embodiments of the present invention. The system for pushing content in an Internet community includes an information pushing module 202 and an acquiring module 204. The system for pushing content in an Internet community may be a software unit built-in a client, a hardware unit, or a unit integrating software and hardware.

The information pushing module 202 is configured to receive information of a display area currently activated by a user from a client.

The acquiring module 204 is configured to acquire, according to the information of the display area currently activated by the user, the latest community content corresponding to the display area from a data storage module.

The information pushing module 202 is further configured to push the latest community content to a corresponding display area of the client.

The data storage module is configured to manage access of all community data, and perform data exchange with other modules of the server.

According to the embodiments of the present invention, the system for pushing content in an Internet community further includes an operation management module.

The operation management module is configured to receive a community content operation result submitted by the client, and store the operation result into a data storage module.

The information pushing module 202 is further configured to return information of the operation result to the corresponding display area of the client.

According to a preferred embodiment of the present invention, the system for pushing content in an Internet community further includes a search management module.

The search management module is configured to receive a keyword submitted by the client for searching hotspot content; and acquire corresponding content from the data storage module according to the keyword, and return the content to the corresponding display area of the client.

In conclusion, according to the embodiments of the present invention, when the cursor of a user stays in display area of a relationship chain content display module or a hotspot content display module, a corresponding display module is triggered to send information indicating which display module is currently activated by the user to a server; the server acquires, according to the information of display module currently activated by the user, the latest community content corresponding to the display module from a data storage module, and pushes the latest community content to the corresponding display module of a client; and the display module of the client, after receiving the latest community content, displays the latest community content in the display area of the corresponding display module for the user to view. According to the embodiments of the present invention, users, after simply setting a user viewing range or customizing a concerned keyword or subject, can view community created by users within the set range by using the real-time pushing function in real time. This greatly simplifies the operation manner of users, and enhances user's real-time viewing experience.

It is understandable to those skilled in the art that all or partial steps of the preceding method can be implemented by hardware following instructions of programs. The programs may be stored in a computer readable storage medium. The storage medium may be a read only memory (ROM), random access memory (RAM), a magnetic disk or a compact disc read-only memory (CD-ROM).

The above descriptions are merely preferred embodiments of the present invention, but are not intended to limit the present invention. Any modification, equivalent replacement, or improvement made without departing from the spirit and principle of the present invention should fall within the protection scope of the present invention.

What is claimed is:

1. A method for acquiring content in an Internet community, comprising the following steps:
when the cursor of a client stays in a relationship chain content display area or a hotspot content display area, triggering the client to send information of the display area currently activated by a user to a server; and
displaying the latest community content in the corresponding display area after the client receives the latest community content.

2. The method according to claim 1, wherein the displaying the latest community content in a corresponding display area after the client receives the latest community content specifically comprises:
after the client receives the latest community content, determining a display area to which the latest community content belongs, and displaying the latest community content in the corresponding display area.

3. The method according to claim 1, further comprising the following steps:
submitting, by the client, an operation result to the server after the user performs an operation on community content on the client; and
receiving, by the client, information of the operation result returned from the server, and displaying the information in the corresponding display area for the user to view.

4. The method according to claim 1, further comprising the following steps:
receiving, by the client, a keyword entered by the user for searching hotspot content, and submitting the keyword to the server; and
receiving, by the client, a search result returned from the server, and displaying the search result in the corresponding display area for the user to view.

5. The method according to claim 1, wherein after triggering the client to send information of the display area currently activated by a user to a server, the method further comprises:
receiving, by the server, information of the display area currently activated by the user from the client;
acquiring, by the server, according to the information of the display area currently activated by the user, the latest community content corresponding to the display area; and
pushing, by the server, the latest community content to the corresponding display area of the client.

6. A system for acquiring content in an Internet community, comprising:
a triggering module, configured to, when the cursor of a client stays in a relationship chain content display area or a hotspot content display area, trigger the client to send information of the display area currently activated by a user to a server; and
a display control module, configured to display the latest community content in a corresponding display area after the client receives the latest community content.

7. The system according to claim 6, further comprising:
a data real-time updating module, configured to, after the client receives the latest community content, determine a display area to which the latest community content belongs, and display the latest community content in the corresponding display area.

8. The system according to claim 6, further comprising:
a submitting module, configured to submit an operation result to the server after the user performs an operation on community content on the client;
wherein the display control module is further configured to receive information of the operation result returned by the server, and display the information in the corresponding display area for the user to view.

9. The system according to claim 6, further comprising:
a keyword submitting module, configured to receive a keyword entered by the user for searching hotspot content, and submit the keyword to the server;
wherein the display control module is further configured to receive a search result returned by the server, and display the search result in the corresponding display area for the user to view.

10. A client including a system for acquiring content in an Internet community according to any one of claims 6-9.

11. A method for pushing content in an Internet community, comprising the following steps:
receiving, by a server, information of the display area currently activated by a user from a client;
acquiring, by the server according to the information of the display area currently activated by the user, the latest community content corresponding to the display area; and
pushing, by the server, the latest community content to the corresponding display area of the client.

12. The method according to claim 11, further comprising the following steps:
receiving, by the server, a community content operation result submitted by the client, and storing the operation result into a data storage module; and
returning, by the server, the information of the operation result to the corresponding display area of the client.

13. The method according to claim 11, further comprising the following steps:
receiving, by the client, a keyword submitted by the client for searching hotspot content;
acquiring, by the server according to the keyword, corresponding content from the data storage module, and returning the content to the corresponding display area of the client.

14. The method according to claim 11, wherein prior to receiving, by a server, information of the display area currently activated by a user from a client, the method further comprises:
when the cursor of the client stays in a relationship chain content display area or a hotspot content display area, triggering the client to send the information of the display area currently activated by the user to the server; and

15. The method according to claim 11, wherein after pushing, by the server, the latest community content to the corresponding display area of the client, the method further comprises:
displaying the latest community content in the corresponding display area after the client receives the latest community content.

16. A system for pushing content in an Internet community, comprising:
an information pushing module, configured to receive information of the display area currently activated by a user from a client; and
an acquiring module, configured to acquire, according to the information of display area currently activated by the user, the latest community content corresponding to the display area;
wherein the information pushing module is further configured to push the latest community content to the corresponding display area of the client.

17. The system according to claim 16, further comprising:
an operation management module, configured to receive a community content operation result submitted by the client, and store the operation result into a data storage module;
wherein the information pushing module is further configured to return information of the operation result to the corresponding display area of the client.

18. The system according to claim 16, further comprising:
a search management module, configured to receive a keyword submitted by the client for searching hotspot content; and acquire corresponding content from the data storage module according to the keyword, and return the content to the corresponding display area of the client.

19. A server including a system for pushing content in an Internet community according to any one of claims 16-18.
